(19) United States
(12) Patent Application Publication
(10) Pub. No.: US 2025/0062487 A1
(43) Pub. Date: Feb. 20, 2025

(54) GAS DEFLECTOR HAVING COOLING VENTS

(71) Applicant: FCA US LLC, Auburn Hills, MI (US)

(72) Inventors: Mark Doroudian, Novi, MI (US); Sreekanth Surapaneni, Oakland, MI (US); Venkata Chagarlamudi, Rochester Hills, MI (US)

(21) Appl. No.: 18/449,777

(22) Filed: Aug. 15, 2023

(51) Int. Cl. H01M 50/358; H01M 10/613; H01M 10/625; H01M 10/6566

(52) U.S. Cl. CPC H01M 50/358; H01M 10/613; H01M 10/625; H01M 10/6566; H01M 2220/20

(57) ABSTRACT

A vehicle including a battery pack including a housing and a plurality of battery cells positioned in the housing, the housing including at least one discharge vent configured to discharge gases generated by the battery cells from the housing; and a manifold attached to the housing and configured for receipt of the gases generated by the battery cells from the at least one vent, wherein the manifold includes a plurality of cooling vents that are configured to permit ambient air to enter the manifold to intermix with the gases generated by the battery cells.

### FIELD

The present disclosure relates to a gas deflector having cooling vents.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure, and is not a comprehensive disclosure of its full scope or all of its features.

According to a first aspect of the present disclosure, there is provided a vehicle including a battery pack including a housing and a plurality of battery cells positioned in the housing, the housing including at least one discharge vent configured to discharge gases generated by the battery cells from the housing; and a manifold attached to the housing and configured for receipt of the gases generated by the battery cells from the at least one vent, wherein the manifold includes a plurality of cooling vents that are configured to permit ambient air to enter the manifold to intermix with the gases generated by the battery cells.

According to the first aspect, the cooling vents each include an aperture and a fluid deflecting tab, wherein the aperture is configured to permit the ambient air to enter the manifold and the fluid deflecting tab is configured to deflect the gases generated by the battery cells in the manifold to intermix with the ambient air.

According to the first aspect, the manifold includes a primary panel and a side surface, and the fluid deflecting tabs are angled relative to the primary panel and the side surface in a range of 15 to 45 degrees.

According to the first aspect, the fluid deflecting tabs are planar members.

According to the first aspect, the manifold includes a deflector in communication with the at least one discharge vent, and a conduit in communication with the deflector.

According to the first aspect, each of the deflector and the conduit include the cooling vents.

According to the first aspect, the deflector includes a primary panel having an outer surface that faces away from battery pack, an opposite inner surface that faces battery pack, a side surface that travels about a perimeter of the primary panel and connects the primary panel to an outwardly extending flange that is configured to mate with an exterior surface of the housing.

According to the first aspect, the cooling vents are formed in each of the primary panel and side surface.

According to the first aspect, the cooling vents formed in the primary panel are positioned in a pattern.

According to the first aspect, the cooling vents are formed in the primary panel randomly.

According to the first aspect, the deflector includes a plurality of flow directing features that are configured to create a turbulent flow within the manifold.

According to a second aspect of the present disclosure, there is provided a method for cooling gases generated by a battery cell that includes collecting the gases generated by the battery cell in a manifold; drawing ambient air into the manifold through a plurality of cooling vents formed in the manifold; intermixing the gases generated by the battery cell collected in the manifold with the ambient air using a plurality of fluid deflecting tabs located in the manifold, the intermixing of the gases and the ambient air cooling the gases; and discharging the intermixed gases and ambient air from the manifold through a conduit.

According to the second aspect, the cooling vents each include an aperture that permits the ambient air to enter the manifold.

According to the second aspect, the intermixing of the gases and the ambient air dilutes the gases generated by the battery cell.

According to the second aspect, the manifold include a primary panel and a side surface, and the fluid deflecting tabs are angled relative to the primary panel and the side surface in a range of 15 to 45 degrees.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle according to a principle of the present disclosure;

FIG. 2 is a perspective view of an example battery pack of the vehicle illustrated in FIG. 1;

FIG. 3 is a perspective view of the example battery pack illustrated in FIG. 2 including a manifold attached thereto;

FIG. 4 is a perspective view of the manifold illustrated in FIG. 3;

FIG. 5 is a partial perspective view of the manifold illustrated in FIG. 4; and

FIG. 6 is a partial cross-sectional view of the manifold illustrated in FIG. 4.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

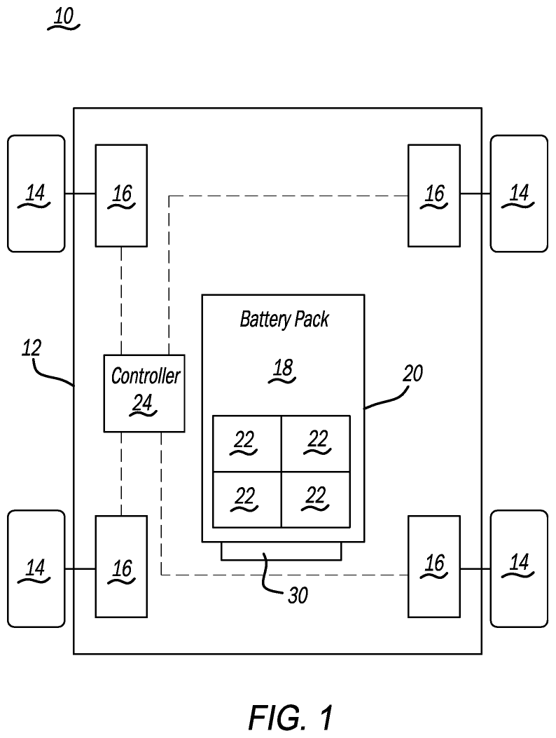

FIG. 1 schematically illustrates an electric vehicle 10 according to the present disclosure. Vehicle 10 includes a body 12, a plurality of wheels 14. In the illustrated embodiment, each wheel 14 is driven using a respective electric drive module 16 that receives electric power from a battery pack 18 having a housing 20 that encases a plurality of battery cells 22. Example battery cells 22 include lithium-ion battery cells, lithium-metal battery cells, and combinations thereof. It should be understood, however, that other types of battery cells 22 known to one skilled in the art may be used, without limitation. Housing 20 is preferably formed of a rigid metal material (e.g., steel, aluminum, and the like) that is resistant to puncture and is non-flammable.

While FIG. 1 illustrates four electric drive modules 16 such that each wheel 14 can be driven by a single electric drive module 16, it should be understood that vehicle 10 may include a single electric drive module 16 for driving a pair of wheels 14 (e.g., for driving the pair of front wheels 14 or the pair of rear wheels 14), or may include a pair of electric drive modules 16 with one of the electric drive modules 16 driving the front pair of wheels 14 and another of the electric drive modules 16 driving the rear pair of wheels 14. Regardless of the configuration selected, it should be understood that electric drive modules 16 receive a voltage or current from battery pack 18 that is utilized by the electric drive module 16 to drive the wheels 14 of the vehicle 10.

Vehicle 10 also includes a controller 24 in communication with each of the drive modules 16 and in communication with the battery pack 18. Controller 24 may be used to control electric drive modules 16 to control a speed of vehicle 10, and may also be used to monitor and/or communicate with various systems of vehicle such as an HVAC system (not shown), a vehicle braking system (not shown), and any other system that may be part of vehicle 10.

As noted above, battery cells 22 may sometimes undergo a process called thermal runaway during failure conditions of the battery cell(s) 22. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 18 increases, the pressure within battery pack 18 also increases.

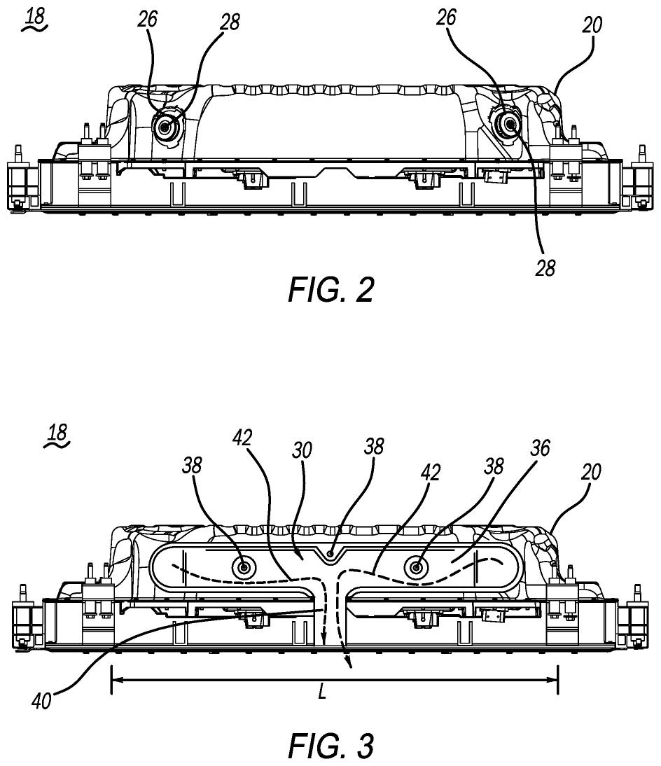

Now referring to FIG. 2, it can be seen that housing 20 of battery pack 18 includes a plurality of discharge vents 26 that permit the pressure and gases to escape housing 20 during a thermal runaway event. Discharge vents 26 may each include a valve 28 that may be a one-way valve and opens upon a predetermined pressure threshold being generated within housing 16. For example, if the pressure within housing 20 reaches 100 millibars the valves 28 may open and permit the gases within housing 20 to exit the battery pack 18. Discharge vents 26 may be in communication with various conduits (not shown) located in battery pack 18, which direct the gases generated during the thermal runaway event to the discharge vents 26 to be expelled from battery pack 20.

While housing 20 may include discharge vents 26 including valves 28 for releasing the gases from battery pack 12, the gases released from battery pack 18 may collect beneath the vehicle 10. While only a pair of discharge vents 26/valves 28 are illustrated in FIG. 2, it should be understood that battery pack 18 may include a greater number of discharge vents 26/valves 28 without departing from the scope of the present disclosure. If the gases are at a sufficient temperature, the gases may combust after exiting battery pack 18 at a location beneath vehicle 10. If this occurs, there is the potential for other features of the vehicle 10 to also combust including, for example, the tires (not shown) of the wheels 14, hoses (not shown), vehicle brakes (not shown) and other features.

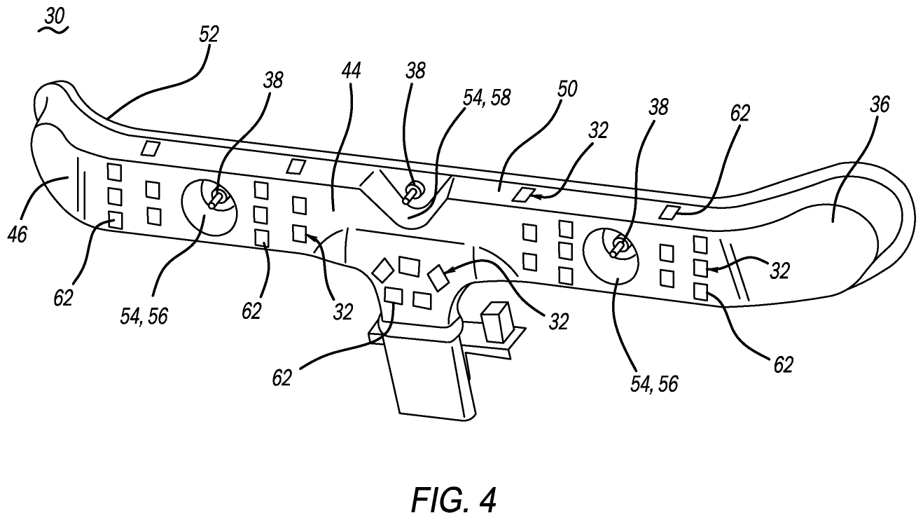

In order to prevent, or at least substantially minimize, the gases that collect beneath vehicle 10 from being at a high temperature that can damage vehicle 10 or components of vehicle 10, it should be understood that battery pack 18 may also include a manifold 30 (FIG. 3) attached to housing 20 of battery pack 18 and in communication with discharge vents 26 that collects and thermally treats the gases that are generated during the thermal runaway event. In this regard, as will be described in more detail below, manifold 30 includes a plurality of cooling vents 32 (see, e.g., FIGS. 4-8) and deflectors 34 for drawing and directing ambient air into the flow of hot battery exhaust gases.

FIG. 3 illustrates battery pack 18 having manifold 30 mounted thereto. Manifold 30 may be formed of a material similar to that of housing 20 (i.e., a rigid metal material (e.g., steel, aluminum, and the like) that is resistant to puncture and is non-flammable). Manifold 30 includes a deflector section 36 that extends along a length L of housing 20 and is rigidly attached to housing 20 at locations 38 using, for example, bolts or some other type of fasteners (not shown). In addition, manifold 30 includes conduit section 40 connected to deflector section 36 that extends in a downward direction (i.e., towards the ground beneath vehicle 10) from deflector section 36. When comparing FIG. 2 with FIG. 3, it can be seen that deflector section 36 covers discharge vents 26 such that upon gases being released from housing 20 through discharge vents 26, the gases 42 will collect in deflector section 36 and be directed in a direction toward conduit section 40 before being directed by conduit section 40 toward the ground beneath vehicle 10. While only a single manifold 30 is illustrated, it should be understood that battery pack 18 may include a plurality of manifolds 30 if desired. For example, each side (e.g., front, back, and left and right sides) of battery pack 18 may include discharge vents 26 that may need a corresponding manifold 30 to collect and direct gases generated during a thermal runaway event.

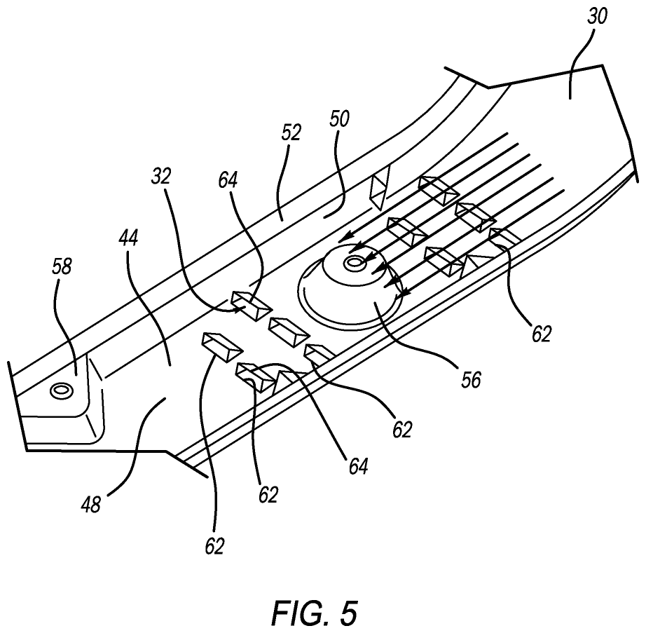

As best shown in FIG. 4, deflector section 36 includes a primary panel 44 having an outer surface 46 that faces away from battery pack 18 and an opposite inner surface 48 (see, e.g., FIG. 5) that faces battery pack 18. A side surface 50 that travels about a perimeter of primary panel 44 connects primary panel 44 to an outwardly extending flange 52 that is configured to mate (i.e., is contoured) with an exterior surface of housing 20. Primary panel 44 may include various flow-deflecting features 54 that are configured to create a turbulent flow within manifold 30. For example, locations 38 where manifold 30 is attached to housing 20 of battery pack 18 may be surrounded by a cup-shaped depression 56 that (as best shown in FIG. 5) forces the flow of battery gases generated during a thermal runaway event to flow therearound. In addition, a recess 58 may collectively be formed in side surface 50 and primary panel 44 that directs or deflects the gases in manifold in a direction toward conduit 40. As will be described in more detail below, the flow-deflecting features 54 assist in intermingling the flow of hot battery exhaust gases with ambient air that is drawn into manifold 30 through a plurality of the cooling vents 32 that are formed in manifold 30. By drawing ambient air into manifold 30 during a thermal runaway event, the hot battery exhaust gases can be cooled and diluted to assist in preventing, or at least substantially minimizing, the gases that collect beneath vehicle 10 from being at a high temperature that can damage vehicle 10 or components of vehicle 10.

As best shown in FIG. 5, deflector cooling vents 32 include an aperture 62 stamped in primary panel 44 and side surface 50 at various locations throughout manifold 30. When aperture 62 is formed, a material of manifold 30 is deflected inward (i.e., away from inner surface 48), which forms a fluid deflection tabs 64. In addition to flow-deflecting features 54, air deflection tab 64 are configured to intermix the flow of hot battery exhaust gases generated during the thermal runway event with ambient air that is permitted to enter manifold through apertures 62. As the ambient air and hot battery exhaust gases intermix, the hot battery exhaust gases will become diluted with the ambient air and may also significantly reduce in temperature. In this regard, the exhaust gases emitted by battery pack 18 during the thermal runaway event can be at temperatures up to, for example 500 degrees C. The intermixing of the ambient air drawn through apertures 62 with the hot battery exhaust gases can reduce the temperature of the gases to about 300 degrees C. where the mixture of exhaust gases and ambient air exits manifold through conduit 40. Once the mixture of exhaust gases and ambient air exits conduit 40 and enters the ambient environment, the temperature can be reduced even further. By reducing the temperature of the exhaust gases, as well as diluting the exhaust gases, the likelihood that the exhaust gases may combust is substantially reduced.

The number of cooling vents 32 for drawing the ambient air into manifold 30 is variable. As shown in FIG. 4, there may be about thirty cooling vents 32 that are formed in manifold. It should be understood, however, that a greater or lesser number of cooling vents 32 may be used as desired. Further, the cooling vents 32 can be arranged in a specific pattern (e.g., groups of five as shown in FIG. 4), or the pattern may be random. The primary aspect to keep in mind regarding the number and arrangement of the cooling vents 32 is the amount of ambient air that can be drawn into manifold to properly treat a temperature of the battery gases as well as properly dilute a concentration of the battery gases. Moreover, while apertures 62 and the corresponding tab 64 formed therefrom are illustrated as being square or rectangular in shape, it should be understood that apertures 62 and tabs 64 can have any shape desired by one skilled in the art including round, oval, triangular, or any other shape.

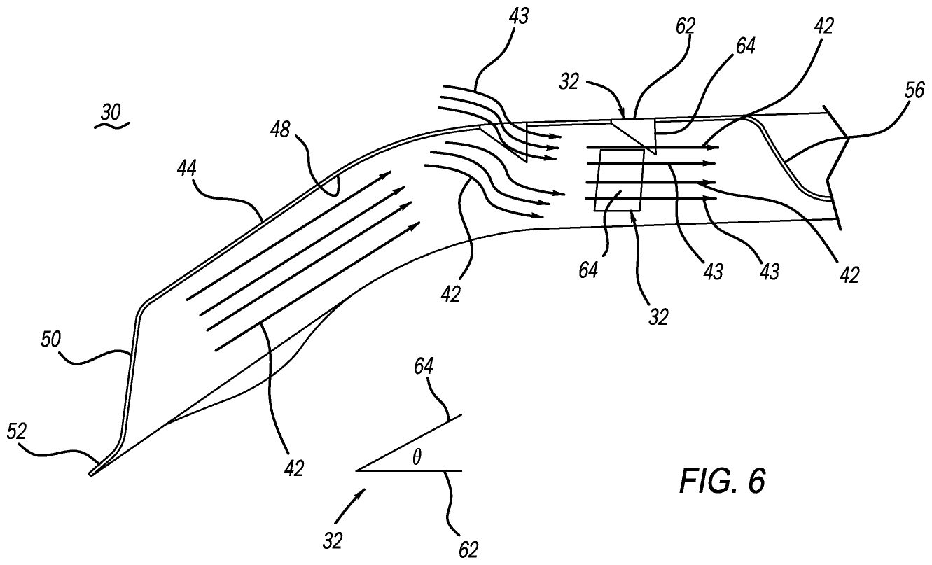

Now referring to FIG. 6, the intermixing of the battery gases generated during a thermal runaway even with the ambient air drawn into manifold 30 will be described. When gases are generated during the thermal runaway event, a temperature of the gases can be about 500 degrees C. As the gases 42 enter manifold 30 from discharge vents 26, the gases 42 may be travelling at a velocity of about seventy m/s and up to the speed of sound (e.g., about 343 m/s). The high speed of the gases 42 flowing into deflector 36 of manifold 30 may create a pressure differential in manifold that can assist in drawing ambient air 43 into manifold 30. As the battery gases 42 flow through deflector 36 of manifold 30 and encounter the fluid deflection tabs 64, the fluid deflection tabs 64 will divert the flow of battery gases 42 within manifold 30. Tabs 64 can have a length of about 10 to 40 mm, and more preferably a length of about 25 mm. A width of tabs 64 can be about 10 to 30 mm. An angle θ at which tabs 64 are bent relative to inner surface of manifold 30 may be in the range of 15 to 45 degrees, and preferably about 30 degrees. Tabs 64 may be planar members, or may be twisted to further swirl and intermix the gases 42 and ambient air 43.

As the gases 42 and ambient air 43 are intermixed by tabs 64 in manifold 30, a temperature of the gases 42 may decrease to a temperature that is substantially less than when the gases 42 exit vents 26 and enter manifold 30. For example, a temperature of gases 42 can be reduced to about 375 degrees C. or lower. This significant reduction in temperature can prevent the gases 42 from causing various features of vehicle (such as vehicle brakes, and the like) from combusting due to contact with the gases 42 as the gases 42 exit conduit 40.

In addition, the intermixing of ambient air 43 with gases 42 significantly dilutes gases 42 to an extent that any flammable species present in gases 42 cannot collect in sufficient quantities beneath vehicle and subsequently combust. Thus, manifold 30 having cooling vents 32 for drawing in ambient air 43 to intermix with gases 42 can be effective in reducing the risks associated with thermal runaway events.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack including a housing and a plurality of battery cells positioned in the housing, the housing including at least one discharge vent configured to discharge gases generated by the battery cells from the housing; and
a manifold attached to the housing and configured for receipt of the gases generated by the battery cells from the at least one vent;
wherein the manifold includes a plurality of cooling vents that are configured to permit ambient air to enter the manifold to intermix with the gases generated by the battery cells.

2. The vehicle according to claim 1, wherein the cooling vents each include an aperture and a fluid deflecting tab, the aperture configured to permit the ambient air to enter the manifold and the fluid deflecting tab configured to deflect the gases generated by the battery cells in the manifold to intermix with the ambient air.

3. The vehicle according to claim 2, wherein the manifold include a primary panel and a side surface, and the fluid deflecting tabs are angled relative to the primary panel and the side surface in a range of 15 to 45 degrees.

4. The vehicle according to claim 2, wherein the fluid deflecting tabs are planar members.

5. The vehicle according to claim 1, wherein the manifold includes a deflector in communication with the at least one discharge vent, and a conduit in communication with the deflector.

6. The vehicle according to claim 5, wherein each of the deflector and the conduit include the cooling vents.

7. The vehicle according to claim 5, wherein the deflector includes a primary panel having an outer surface that faces away from battery pack, an opposite inner surface that faces battery pack, a side surface that travels about a perimeter of the primary panel and connects the primary panel to an outwardly extending flange that is configured to mate with an exterior surface of the housing.

8. The vehicle according to claim 7, wherein the cooling vents are formed in each of the primary panel and side surface.

9. The vehicle according to claim 7, wherein the cooling vents formed in the primary panel are positioned in a pattern.

10. The vehicle according to claim 7, wherein the cooling vents are formed in the primary panel randomly.

11. The vehicle according to claim 5, wherein the deflector includes a plurality of flow directing features that are configured to create a turbulent flow within the manifold.

12. A method for cooling gases generated by a battery cell, comprising:
collecting the gases generated by the battery cell in a manifold;
drawing ambient air into the manifold through a plurality of cooling vents formed in the manifold;
intermixing the gases generated by the battery cell collected in the manifold with the ambient air using a plurality of fluid deflecting tabs located in the manifold, the intermixing of the gases and the ambient air cooling the gases; and
discharging the intermixed gases and ambient air from the manifold through a conduit.

13. The method according to claim 12, wherein the cooling vents each include an aperture that permits the ambient air to enter the manifold.

14. The method according to claim 13, wherein the intermixing of the gases and the ambient air dilutes the gases generated by the battery cell.

15. The method according to claim 12, wherein the manifold include a primary panel and a side surface, and the fluid deflecting tabs are angled relative to the primary panel and the side surface in a range of 15 to 45 degrees.
